(19) United States
(12) Patent Application Publication
(10) Pub. No.: US 2006/0016311 A1
(43) Pub. Date: Jan. 26, 2006

(54) Folding saw frame

(76) Inventor: Kerry R. Seymour, Perry, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/111,537

(22) Filed: Apr. 21, 2005

Related U.S. Application Data
(60) Provisional application No. 60/564,161, filed on Apr. 21, 2004.

(51) Int. Cl. B26D 1/00

(52) U.S. Cl. 83/651

(57) ABSTRACT

A saw frame that may be folded and locked in a more compact position. One saw frame disclosed comprises a first section of the frame that is pivotably attached to a second section of the frame so that the first section can pivot upward and fold back down onto the second section, resulting in a considerably more compact structure when folded. The pivot point is located so that, when folded, the frame can be lifted from a handle or lifting point at the frame's folded center of gravity without substantially tilting. Locking pins secure the frame in its folded or open configurations, so that the frame is not permitted to pivot when not desired.

### RELATED APPLICATIONS

This non-provisional application claims the benefit of U.S. Provisional Application Ser. No. 60/564,161, filed Apr. 21, 2004 and entitled “Folding Saw Frame,” the entire contents of which are incorporated by this reference.

### FIELD OF INVENTION

This invention relates to a saw frame for cutting felled trees to length and, more particularly, to a saw frame that is foldable to a relatively compact configuration.

### BACKGROUND

In the logging industry, it is known to use a saw to cut felled trees to length. Typically, the saw is mounted to a large saw frame. In use, the operator places one or more felled trees on the frame and then activates the saw, which pivots down to remove a length of the tree or trees.

In order to accommodate large felled trees, saw frames typically are large, bulky structures. The frames typically have an elongated shape, in which the length is substantially greater than the width. The substantial length of such frames makes lifting the frame awkward and difficult. Further, the length of the frame requires a very large transport vehicle to carry the frame from one worksite to another.

Thus, there is a need for an improved saw frame that can be folded to a relatively compact configuration for easier lifting and transport

### SUMMARY OF THE INVENTION

This invention is a saw frame that may be folded to a more compact configuration and locked in position. The invention may be embodied in a variety of ways.

The saw frame of this invention supports felled trees in a horizontal position with a series of support members positioned to be transverse to the tree trunks to support the trunks while they are cut into shorter lengths. The support members can be horizontal, vee-shaped to cause the tree trunks to slide into a central location or have other desired configurations. The frame provides a structure that holds the support members during use, spaced apart from each other over a fairly substantial length, typically connecting the support members in some appropriate fashion. Vertical frame members may be located at frame longitudinal edges to prevent tree trunks from sliding off of the frame.

In the saw frame of this invention, a first section of the frame is pivotably attached to a second section of the frame so that the first section can pivot upward and fold back down onto the second section. By careful selection of the lengths of frame components and appropriate positioning of the frame components, most components of the first and second frame sections do not contact each other when folded but instead more or less “interweave” so that the first section can rotate to a position above and almost parallel with the second section, thereby resulting in a considerably more compact structure when folded.

Furthermore, the pivot point is located so that, when folded, the frame can be lifted from a handle or lifting point at the center of gravity of the folded frame without substantially tilting. This makes it easy to lift the frame and move it from one location to another, including from the ground to a truck or trailer on which it is to be transported.

Locking pins secure the frame in its folded or open configurations, so that the frame is not permitted to pivot when not desired.

The present invention may be better understood by reference to the description and figures that follow. The invention is not limited in its application to the specific details as set forth in the following description and figures. The invention is capable of other embodiments.

### BRIEF DESCRIPTION OF THE DRAWINGS

These and other features, aspects, and advantages of the present invention are better understood when the following Detailed Description is read with reference to the accompanying drawings, wherein:

FIG. 1 is a perspective view of one embodiment of the saw frame of this invention in an open position.

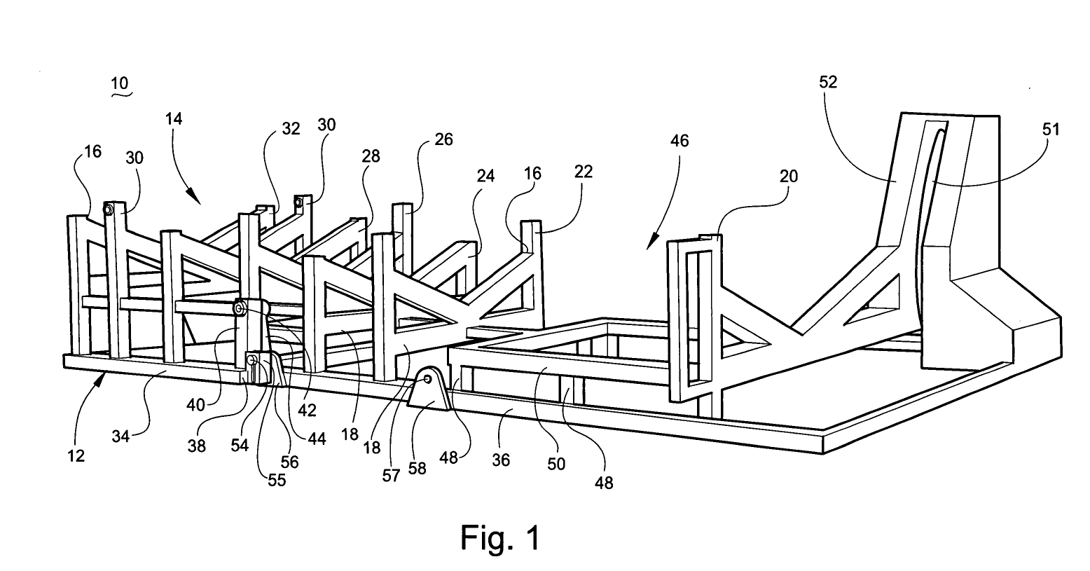

FIG. 2 is a fragmentary perspective view of a saw frame of FIG. 1 shown while being rotated from an open position to a folded, compact configuration.

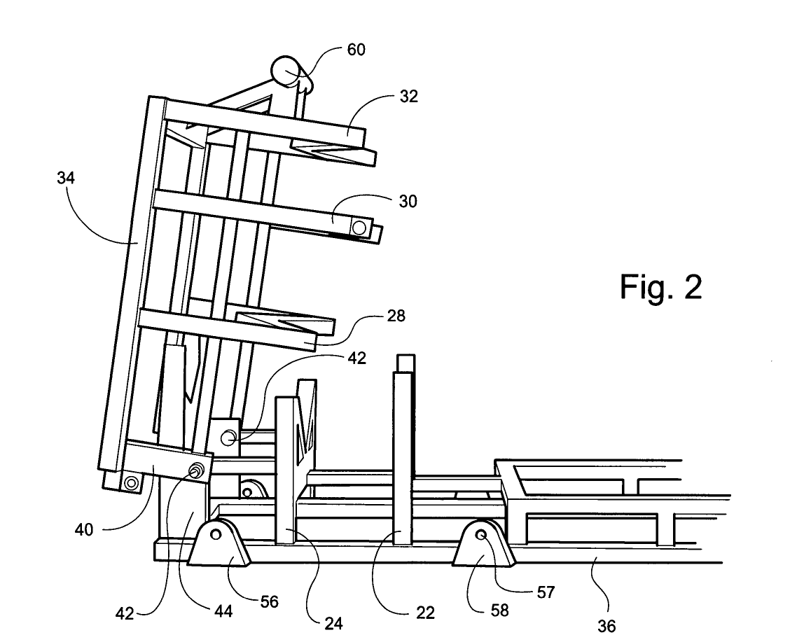

FIG. 3 is a perspective view of the saw frame of FIG. 1 in a fully-folded, compact configuration.

### DETAILED DESCRIPTION

Embodiments of the present invention include a saw frame that is foldable, allowing it to be easily lifted, moved, and transported.

The frame may be constructed of welded tubular steel or any other suitable material.

The frame 10 of this invention shown in the figures, when open, has two parallel rails 12 on which tree trunk supporting and saw supporting structures are mounted. In this embodiment 10, the tree trunks (not shown) are supported by vee-shaped square tubular steel cradles 14 attached to upright posts 20, 22, 24, 26, 28, 30, 32, each of which stands on one of the rails 12. The cradles 14 are horizontally aligned so that each will provide some support for a straight tree trunk resting in the cradles 14.

Taller vertical posts 20, 22, 26, 30 extend above the ends 16 of the cradles 14, to assist in keeping trunks in the cradles 14. However, posts 24, 28, 32 are shorter to facilitate folding the frame 10 as described below.

Rather than being continuous, each rail 12 has two pieces, a pivoting rail 34 and a stationary rail 36 and that lie more or less end to end. An upright 40 is attached to the end 38 of the pivoting rail 34. An axle (or pivot rod) 42 passes through upright 40 and through an upright 44 attached to the stationary rail 36. The pivoting rail 34 pivots about the axle 42.

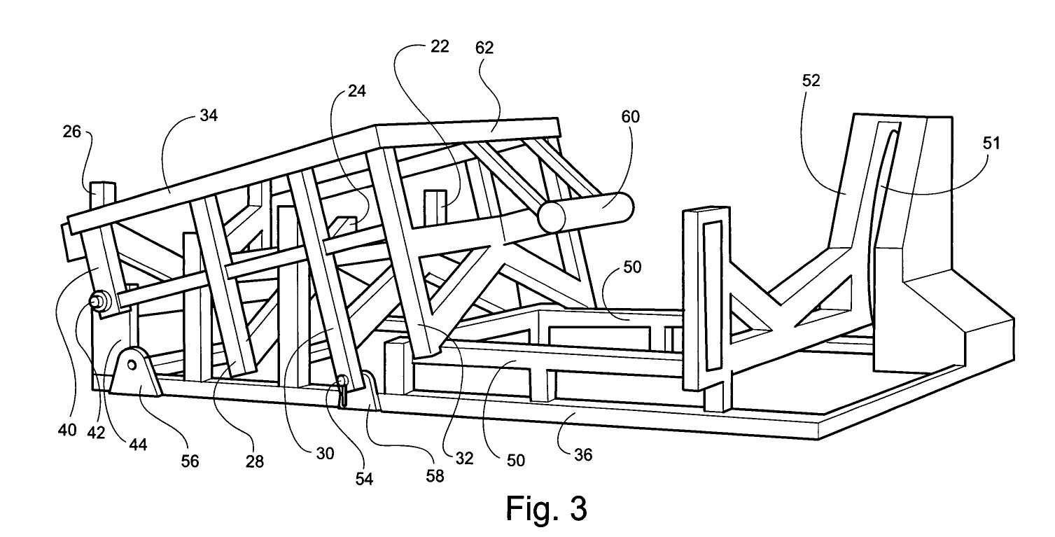

Upright 28 is shorter than upright 30 so that, when the frame 10 is folded closed as shown in FIG. 3, the upper end of upright 30 will contact stationary rail 36. By careful placement of the upright 28 on the pivoting rail 36, upright 28 fits in between upright 22 and upright 24 when the frame 10 is folded closed. Similarly, when in the folded position, uprights 30, 32 extend down toward the stationary rail 36 without contacting upright 22. The frame 10 contains a center section 46, which does not have cradles. The lack of cradles in center section 46 provides an area of the frame 10 into which some of the upright members attached to the pivoting rail 34 may enter when the frame 10 is folded. However, in other embodiments, it is possible to position the upright members such that those attached to the stationary rail 36 interleave with those attached to the pivoting rail 34 when the frame 10 is folded.

The center section 46 has multiple short uprights 48 and three rails 50 supported by the uprights 48. The frame 10 is at rest in the closed (folded) position when the cradle attached to uprights 32 contacts the rails 50 of the center section 46.

Attached to the frame 10 is a saw 51, which is contained in a vertical housing 52 and can pivot down to cut the tree trunks. When not in use, the saw 51 is pivoted up within the vertical housing 52 for safe storage. The saw 51 may be a bucksaw, ground-saw, slasher-saw, or any other saw suitable for cutting felled trees.

The frame 10 may be locked in either an open position or a closed position by a locking pin 54. When the frame 10 is in the open position, the locking pin 54 is placed through a hole in a member 55 attached to the pivoting rail 34 and through a hole in a tab 56, which is attached to the stationary rail 36. When the pin 54 is placed through both holes, the frame 10 is prevented from rotating about the axle 42. The frame 10 may be locked in the closed position by placing a pin 54 through a hole in upright 30 and through a hole 57 in a tab 58, which is attached to the stationary rail 36. The pin 54 must be removed from the holes before the frame 10 can be rotated.

The locking pin 54 may be attached to the frame 10 by a chain or other similar tether, but the tether must be long enough, based on where it is attached to the frame 10, to allow the pin 54 to pass through either tab 56 or tab 58. The frame 10 shown in the figures has one locking pin 54 on either side of the frame 10. Other embodiments may have only one locking pin 54 or more than two locking pins 54.

Locking the frame 10 in the open position makes the frame 10 relatively rigid and able to support a tree trunk without substantial shifting. Locking the frame 10 in the closed position allows the frame 10 to be transported without the danger of the frame rotating back to an open position.

Further facilitating the transport of the frame 10 is a handle 60 attached to the frame 10. The handle 60 may be a steel rod or beam attached by connecting members to a cross member 18 and a base cross member 62, which connects the two pivoting rails 34. The handle 60 provides a convenient place at which a crane or grapple may grasp the frame 10 for lifting and transporting to another location.

In order to minimize tilting of the frame 10 while it is being lifted, the handle 60 is positioned at or near the center of gravity of the folded frame 10. The weight of the frame 10 when it is in the folded position, including the weight of the saw that is attached to the frame 10, should be relatively balanced on either side of the handle 60. If the weight is balanced on either side of the handle 60, the frame 10 will not substantially tilt and the frame 10 will be more easily carried and placed onto a transport vehicle.

The embodiment illustrated in the figures and described above is an example of the present invention; however, other embodiments are possible. For instance, the embodiment above describes attaching each of the members of the frame by welding, but other methods of attachment are possible. Several members may be bolted together or formed of one piece of steel and bent to the desired shape. In addition, the position and number of upright posts and cradles can vary.

The above embodiment describes a frame with vee-shaped cradles 14 supported by cross members 18, but another embodiment may exclude the cradles 14 and allow the tree trunk to rest on the cross members 18. Further, the cross members 18 may increase in height such that each successive cross member 18, moving away from the saw, is slightly higher than the cross member closer to the saw. This is known in the art as a “stair step frame” and allows a tree trunk to abut a cross member 18 or cradle 14 that is a known distance from the saw, so that the saw cuts the tree trunk to a desired length without the need to measure. The stair step frame may be used with or without cradles 14. In the alternative, all cross members 18 may be positioned at the same height, with or without cradles.

Further, the pivoting rails 34 may pivot about a hinge other than an axle 42. For example, the hinge may be a ball-and-socket joint, a strap hinge, a T-hinge, or any other suitable hinge.

Also, the locking pins 54 may be placed through holes in frame 10 at locations other than those described above. For example, the locking pins 54 may pass through holes in the stationary rail 36 itself rather than through tabs 56, 58 attached to the stationary rail 36.

The frame 10 may also comprise additional members not described above. For example, the frame 10 may contain a center support rail that is parallel to the rails 12 and supports the cross members 18 at the center of the cross members 18. Also, the frame may comprise side support rails that are parallel to rails 12 and support uprights 40, 28, 30, 32. These side support rails may provide more structural rigidity for the portion of the frame 10 that folds.

The foregoing description of illustrative embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1. A saw frame for cutting felled trees to length, the frame comprising:
a first frame portion rotatably attached to a second frame portion to move between an open position and a folded position;
a first removable lock to limit movement of the first portion with respect to the second portion;
a handle attached to the first portion.

2. The frame of claim 1, further comprising a saw attached to the second portion of the frame.

3. The frame of claim 1, further comprising a second removable lock to limit movement of the first portion with respect to the second portion.

4. The frame of claim 1, the handle positioned at the center of gravity of the frame when the frame is in the folded position.

5. The frame of claim 1, the first removable lock comprising a first pin, the first pin passing through a first aperture in the first portion and through a first aperture in the second portion when the frame is in the open position.

6. The frame of claim 3, the second removable lock comprising a second pin, the second pin passing through a second aperture in the first portion and through a second aperture in the second portion when the frame is in the open position.

7. The frame of claim 5, the first pin passing through a third aperture in the first portion and through a third aperture in the second portion when the frame is in the closed position.

8. The frame of claim 6, the second pin passing through a fourth aperture in the first portion and through a fourth aperture in the second portion when the frame is in the closed position.

9. A foldable bucksaw frame comprising:
a stationary frame section comprising at least one log cradle and structure for mounting a pivotable saw;
a pivotable frame section attached to the stationary frame section and pivotable between an open position and a folded position; and
a handle attached to the frame at the approximate center of gravity of the frame when the frame is folded and a pivotable saw is mounted on the frame.

10. The foldable bucksaw frame of claim 9, wherein the handle is adapted to attach to a chain or cable for lifting the frame by the handle.

11. The foldable bucksaw frame of claim 10, further comprising frame components penetrated by pairs of holes that align with each other in each of a fully folded and an open position so that a pin inserted through an aligned such pair of holes will prevent pivoting of the pivotable frame section relative to the stationary frame section.

12. The foldable bucksaw frame of claim 11, wherein the pivotable and stationary frame sections comprise welded, rectilinear cross-section steel tube.
